(19) United States
(12) Patent Application Publication
(10) Pub. No.: US 2007/0143164 A1
(43) Pub. Date: Jun. 21, 2007

(54) Business practice management system

(76) Inventors: Sanjeev Kaila, Sarnia (CA); Rajeev Kaila, Lawrenceville, GA (US)

Correspondence Address: HARNESS, DICKEY & PIERCE, P.L.C., P.O. BOX 828, BLOOMFIELD HILLS, MI, 48303, US

(21) Appl. No.: 11/291,270

(22) Filed: Dec. 1, 2005

(51) Int. Cl. G06Q 99/00; G05B 19/418; G06F 15/02

(52) U.S. Cl. 705/8; 705/9; 705/1

(57) ABSTRACT

A business practice management system includes a client contact management workflow made up of multiple stages of interaction between users of the system and clients of a business practice. Tasks, events, forms, and conditions of the stages provide conditions for moving from one stage to another, and define interactions between the users of the system, the clients of the business practice, and information relating to the assets of the business practice. A global business practice management workflow can also be included to manage assets as needed independently of client contact stages. User interfaces employ the workflows to interactively direct users of the system in managing multiple categories of assets of the business practice, including employees, client accounts, inventory, and records.

### FIELD OF THE INVENTION

The present invention relates generally to business practice management systems. More particularly, the invention relates to an internet-based business practice management system.

BACKGROUND

Today's business practices need to manage various types of assets, including inventory, employees, client accounts, and records. Automating this management is a difficult task. Previous attempts to automate business practice asset management has led to a number of expensive, inadequate, mismatched tools that quickly become obsolete.

What is needed is a business practice management system that manages various types of assets of a business practice in an integrated fashion, has the flexibility to be implemented with a wide variety of business practices, is easily adaptable to changes in needs of business practices, and can be delivered to the business practice without requiring investment in equipment or products. The present invention fulfills these needs.

### SUMMARY OF THE INVENTION

In accordance with the present invention, a business practice management system includes a client contact management workflow made up of multiple stages of interaction between users of the system and clients of a business practice. Tasks, events, forms, and conditions of the stages provide conditions for moving from one stage to another, and define interactions between the users of the system, the clients of the business practice, and information relating to the assets of the business practice. A global business practice management workflow can also be included to manage assets as needed independently of client contact stages. User interfaces employ the workflows to interactively direct users of the system in managing multiple categories of assets of the business practice, including employees, client accounts, inventory, and records.

For a more complete understanding of the invention, its objects and advantages, refer to the remaining specification and to the accompanying drawings.

### BRIEF DESCRIPTION OF THE DRAWINGS

The present invention will become more fully understood from the detailed description and the accompanying drawings, wherein:

FIG. 1 is a block diagram of an online business practice management system in accordance with the present invention;

FIG. 2A is a block diagram illustrating a business practice management system in accordance with the present invention;

FIG. 2B is a block diagram illustrating a translator module interfacing a medical information management system with multiple Electronic Medical Record (EMR) systems employing incompatible medical data communication languages in accordance with the present invention;

FIG. 2C is a flow diagram illustrating an anatomical notation data access and retrieval interface method in accordance with the present invention;

FIG. 3 is a block diagram illustrating a workflow software sub-system of the business practice management system in accordance with the present invention;

FIG. 4 is a block diagram illustrating an inventory management sub-system of the business practice management system in accordance with the present invention;

FIG. 5 is a flow diagram illustrating a method of manufacturing a business practice management system in accordance with the present invention;

FIG. 6 is a flow diagram illustrating a method of providing an online business practice management system in accordance with the present invention;

FIG. 7 is a block diagram illustrating an online business practice manager generation system in accordance with the present invention; and

FIG. 8 is a block diagram illustrating business practice manager generation services of the online business practice manager generation system in accordance with the present invention.

### DETAILED DESCRIPTION OF THE PREFERRED EMBODIMENTS

The following description of the preferred embodiments is merely exemplary in nature and is in no way intended to limit the invention, its application, or uses.

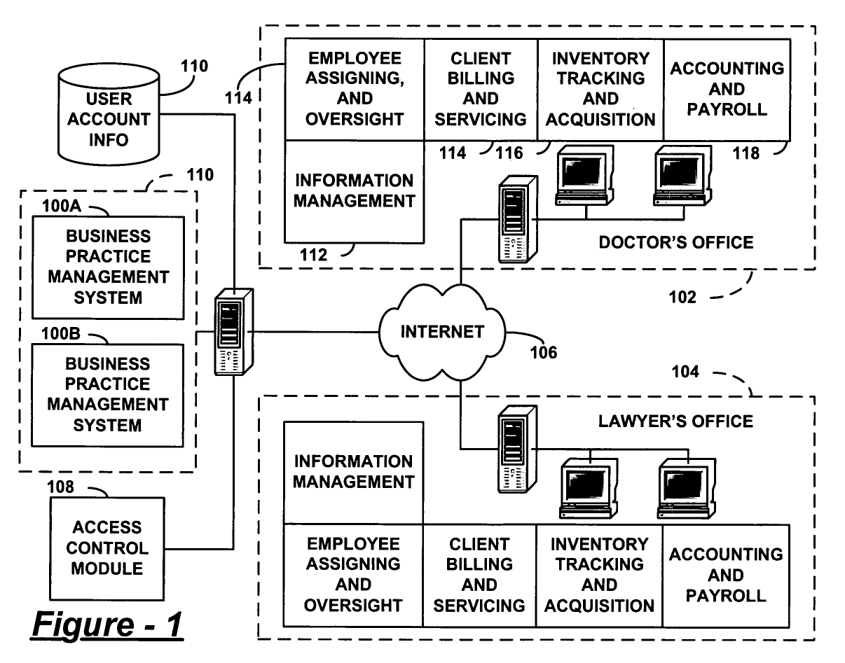

Referring to FIG. 1, an online business practice management system in accordance with the present invention provides business practice management services 100 to users 102 and 104 over a communications system 106, such as the Internet. For example, a doctor's office user 102 can sign on to its business practice management system 100A via access control module 108, which can identify the user 102 based on information in user accounts datastore 110. Lawyer's office user 104 can similarly sign on to business practice management system 100B. System 100A is customized to manage the practice of the doctor's office user 102 by handling information management 112, employee assigning and oversight 114, client billing and servicing 116, inventory tracking and acquisition 118, and accounting and payroll 120 needs of the user 102. System 100B is similarly customized for user 104. For purposes of illustration, an embodiment of the present invention ids further described below in the context of a management system for use with a doctor's office providing medical services. However, it should be readily understood that the present invention can be employed with any type of business practice and modified accordingly as will be readily apparent to one skilled in the art.

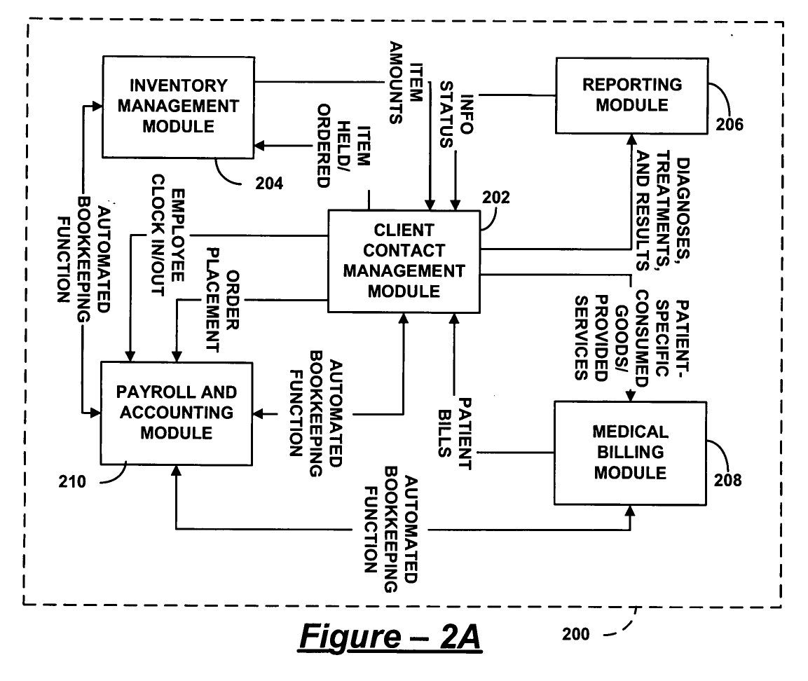

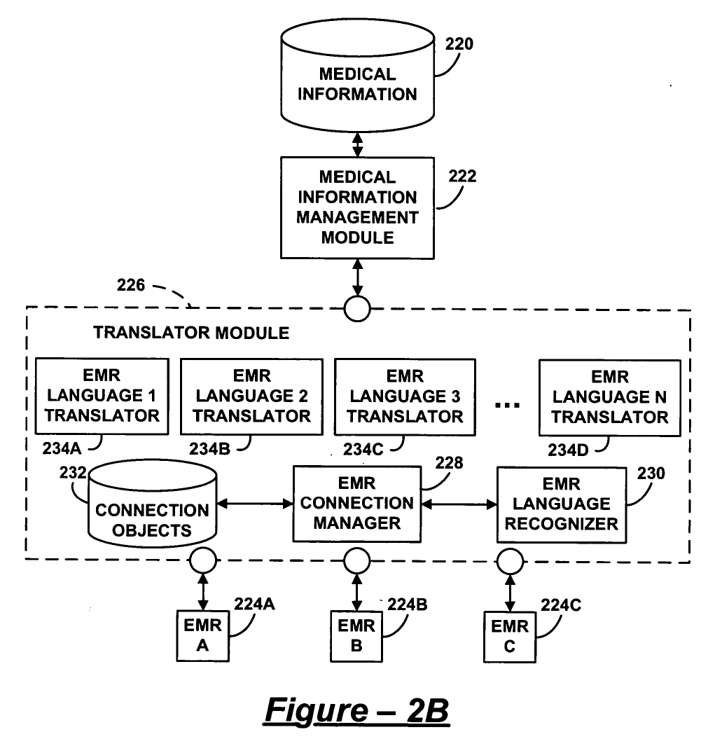

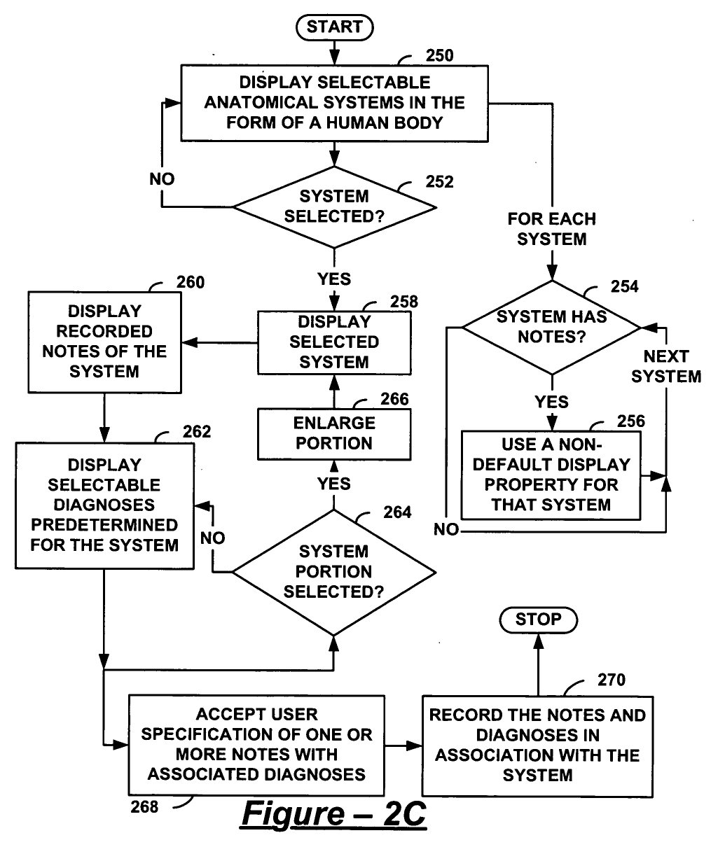

Turning now to FIG. 2, business practice management system 200 employs a client contact management module 202 as a central component directing interaction of employees with clients of the business practice and with information relating to assets of the business practice. Client contact management module 202 is integrated with inventory management module 204, reporting module 206, medical billing module 208, and payroll and accounting module 210. For example, forms of client contact management module 202 are able to obtain item amounts from inventory management module 204. Also, controls of those forms can send item hold events to inventory management module in order to reserve inventory needed in a scheduled service to be rendered to a client. Similarly, order placement notifications can be sent from module 202 to inventory management module 204. Further, client contact management module 202 can generate reports to be stored by reporting module 206, such as diagnoses, treatments, and results, which can later be retrieved by client contact management module 202.

Turning now to FIG. 2C an anatomical notation system portion of the reporting software provides a unique way for doctors to write or dictate their notes and make a diagnosis. Beginning with step 250, a physician user is presented with display of icons representing selectable anatomical systems in the form of a three dimensionally rendered picture of the human body (either male or female depending on the patient). Then, at step 252, the physician user selects one of the body systems (i.e., muscular, skeletal, organs, etc.).

Once the system is selected, the 3D image adjusts to display the correct system at step 258. Next, the doctor is able to click on any portion of the displayed current system at step 264 to enlarge that portion at step 266, and continue in this fashion in order to “drill down” as far as he or she would like. Any notes recorded for the current subsystem are also displayed at step 260. Selectable diagnoses for the system are further displayed for selection at step 262, and these diagnosis choices can vary from system to system. Thus, once in the correct area, the doctor can type or dictate (i.e. record audibly) his or her note and select from the list of selectable diagnoses associated with that area of the body at step 268. These notes are then stored in association with the displayed system for that patient at step 270.

Display of symbols representing selectable systems at step 252 can vary depending on presence of notes recorded in association with a system as at step 254. In particular, a non-default display property can be used to display systems that have notes as at step 256. For example, the next time somebody looks at the 3D image for that patient, any area that already has a note entered into it can show up as the color red. This makes it easy for a doctor to quickly assess which areas of the patient have had previous issues. Also, different display properties can be employed for different kinds of notes to differentiate, for example, resolved issues from unresolved issues. Moreover, notes may be organized anatomically as described above or in chronological order as well. Therefore, this system is a new way of categorizing notes. Each note has a system, body area, and diagnosis linked to it. This system allows for easier searching later on when performing clinical research.

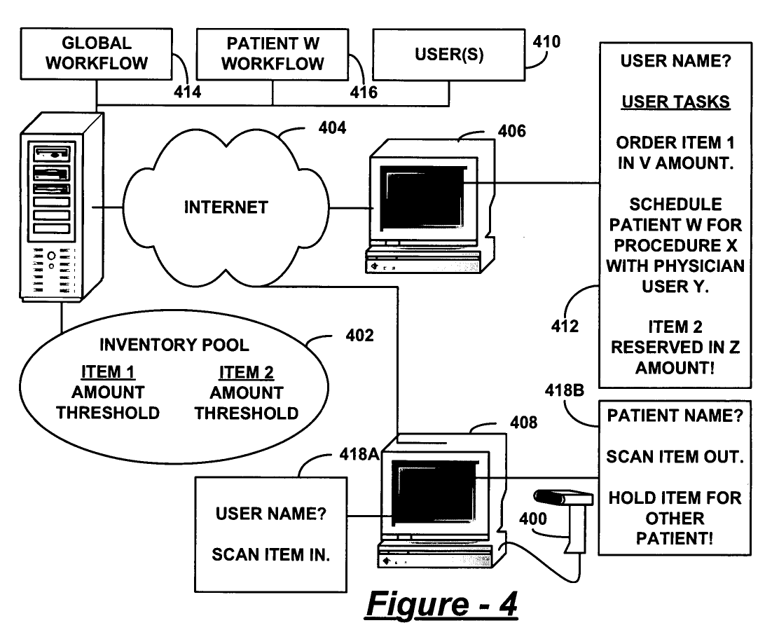

Returning now to FIG. 2A, modules of the system are integrated with one another and with the accounting module 210 to accomplish automated billing and bookkeeping functions. For example, client contact management module 202 can communicate goods and services consumed by a client to billing module 208, which can generate a client invoice for client contact management module 202. Further still, payroll and accounting module 210 can keep track of employee time by sensing employees clocking in an out of the client contact management module 202, and can receive order placement information from module 202 so that supplier invoice payment can be authorized. Finally, payroll and accounting module 210 can communicate amounts owed by clients to module 202, and receive notifications of amounts paid. Therefore, the payroll and accounting module 210 can be tied to client contact management module 202, inventory management module 204, and billing module 208 to accomplish respective automated billing functions. Some of these functions are described above, while others are detailed further below with reference to FIG. 4.

It is envisioned that all client information can be stored completely electronically and can be accessed over the Internet. In the medical fields, all patient notes, all clinical forms, and all lab tests and images are preferably stored completely online to facilitate access to patient information. In such an application, reporting module 206 (FIG. 2A) preferably includes a dictation module that allows users to record audio notes over the Internet for particular clients. The audio data can then be converted to text using either computerized voice recognition software or manual labor. Either of these options can be selected based on the sensitivity of the data. Once converted to text, the text data can be stored in a proper client file.

Turning now to FIG. 2B, in some embodiments, medical records storage is enhanced to correct one of today's major problems in the medical IT industry. This problem is the lack of a communications standard. In particular, there are numerous messaging languages that have been developed that allow different software packages to communicate, but since there are so many, often times software packages speak different languages and are unable to communicate. Therefore, a presently preferred embodiment of the present invention employs a translator module 226 that allows multiple Electronic Medical Record (EMR) systems 224A-C to speak to a medical records management sub-system of the present invention, including medical information management module 222 accessing medical information datastore 220, and to use that sub-system as a means to communicate with each other. This translator module 226 is designed to sit between the sub-system and other EMR systems, and to translate the languages that those EMR systems speak into a proprietary language of the sub-system. One such messaging language that can be understood by this translator is Health Level 7 (HL7). Another standard is the DICOM standard that has been created for medical images. The translator module is not only able to accept messages and store data in the sub-system database, but is also able to accept requests for data and send data out to a requesting EMR application.

In some embodiments, the translator module has an EMR connection manager that routes data between medical information management module 222 and a particular EMR system based on data in a connection object of datastore 232. For example, connection manager 228 can create the call object when the connection is initialized by the EMR system, and record in the object information indicative of the EMR language employed by the EMR system. For instance, EMR connection manager 228 can employ EMR language recognizer 230 to determine which of several EMR language translators 234A-D needs to be used throughout the call. In particular, recognizer 230 can analyze a query or other data received from the EMR system in order to identify the appropriate translator. By way of illustration, a try and catch series in which the recognizer tries to use the translators in turn until success is obtained can quickly identify the appropriate translator. Then, EMR connection manager 228 can employ the appropriate translator throughout the connection with the EMR system in order to convert queries and data to and from the language of the EMR system and the proprietary language of the medical information management module 222 and medical information datastore 220.

In essence, the translator module acts as a bridge that allows multiple stand-alone EMR solutions to connect to each other. This new network makes it easier to share patient records across multiple medical institutions. At the same time, this translator module allows the medical records management sub-system of the present invention to become a central storage system for medical information from many different software vendors. This large database of medical information can be used for clinical research to help the medical community.

Using this translator module, the medical records management sub-system of the present invention is able to connect directly to medical laboratories and offices that perform medical imaging, such as X-Rays and CT Scans. In the past, these lab results and medical images would have to be sent in paper format back to the requesting medical institution. However, with the translator module, these results and images can be digitally sent through the translator module and stored digitally within the sub-system database.

Another enhancement in some embodiments is related to electronic prescriptions. The medical community has traditionally used paper and pen to write medical prescriptions. This way of writing prescriptions has sometimes proven to be inefficient. Paper prescriptions are often lost between the doctor's office and the pharmacy, and there is always the risk of a patient fraudulently modifying a prescription. One reason that the medical community has continued to use this method is due to some statutory laws that require prescriptions to be written or faxed to pharmacies.

Some embodiments allow physician users to write a patient's prescription directly on a computer using a light-pen. Once submitted, the prescription can be digitally faxed through the Internet and arrive at the pharmacy. This process eliminates the need for giving the patient a paper prescription, and makes the process more secure.

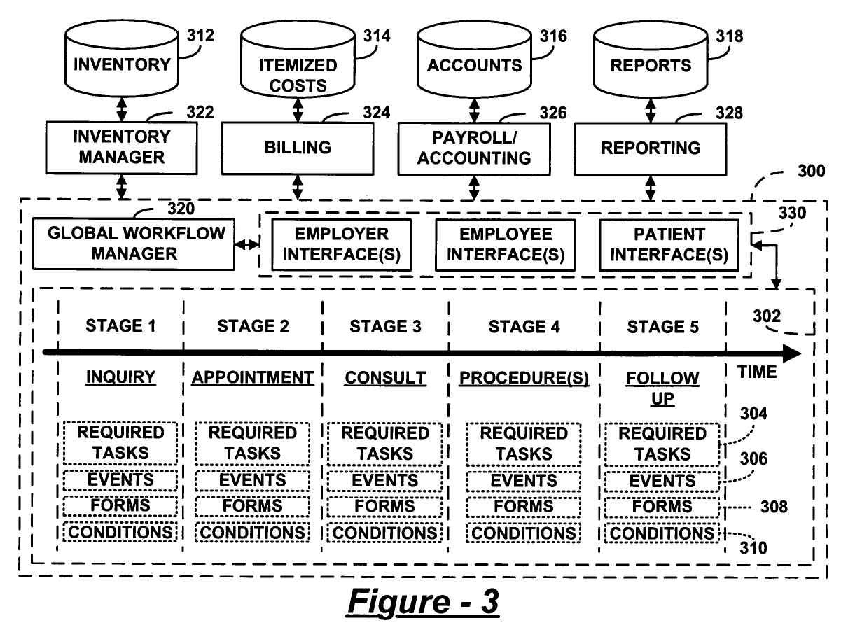

Turning now to FIG. 3, workflow software sub-system 300 of the business practice management system includes a client contact workflow 302 made up of several linearly ordered client contact workflow stages. Each stage is composed of required tasks 304, events 306, forms 308, and conditions 310, including conditions for stage completion. These stages drive interaction of users with business asset information, such as inventory 312, itemized costs 314, client accounts 316, and reports 318, based on client contact. For example, an inquiry stage directs employees to collect and update information in client accounts 316. The inquiry stage can also direct employees to schedule an appointment for the client to meet with staff for a consultation. Then, an appointment stage following completion of the inquiry stage can signify that an appointment has been scheduled, and generate a confirmation task for an employee to call and remind the client the day before the appointment. Further, a consultation stage following completion of the appointment stage generates a consultation task for the staff based on the appointment, and records information provided by the staff about results of the consultation in reports 318. The consultation stage can also direct staff to schedule one or more procedures for the patient based on the consultation.

If needed, one or more procedures stages can follow completion of the consultation stage. In a presently preferred embodiment, there are two sequential stages. The first stage is called “Procedure Booked.” This stage signifies that an appointment for the procedure has been booked and triggers tasks, events, and conditions that must be satisfied before the next stage, which is called “Day of Procedure.” In the “Day of Procedure” stage, all of the tasks, events, and conditions that must be completed on the day of the procedure are triggered.

The tasks, events, and conditions for the “Procedure Booked” stage can involve reserving inventory 312 allocated for performing the procedure or procedures, and generating a bill for goods and services received by the client based on costs 314. It can also direct the employees to invoice the client for the goods and services. In contrast, the “Day of Procedure” stage can involve generating a procedure task to be performed by the staff. When time for the procedure, this stage can further direct employees to remove items out of inventory based on the scheduled procedure. This stage can also involve recording information provided by the staff about results of the procedure in reports 318. The “Day of Procedure” stage can further direct employees to schedule a follow up for the client to meet with the staff following the procedure. Then, a follow up stage following completion of the procedures stage or stages can generate a follow up task to be performed by the staff based on the scheduling of the follow up, and record information provided by the staff about results of the follow up in reports 318.

In addition to the client contact management workflow, a global business practice management workflow 320 directs employees to interact with assets in ways not directly driven by contact with the client. For example, employees can be directed to order items when a number of the items in inventory 312 falls below a predetermined threshold as specified in inventory manager 322. Business process rules embodied in inventory manager 322, billing manager 324, payroll and accounting manager 326, and reporting manager 328 can be wholly or partly embodied in the required tasks 304, events, 306, forms, 308, and conditions 310 defined in the workflows.

The rules of the business practice can also be embodied in part in the user interfaces provided to different classes of users with varying purposes and privileges, such as employers, employees, and patients. For example, employee users can be targeted for certain tasks and employers for others. Also, employers can be privileged to view employee files and advance stages out of turn. Further, patients can be restricted to viewing only their own medical records in the form of a medical history. For example, a patient can be permitted to sign on using an assigned ID and username in order to view their medical history.

Turning now to FIG. 4, an inventory management sub-system of the business practice management system allows users to scan items in and out of inventory using a bar code scanner 400. An inventory pool 402 provided online over communications system 404 to client workstations 406 ad 408 records amount of items in inventory with one or more thresholds for reserving and/or ordering more items. Pool 402 can also record how many of an item have been ordered, when, and by whom. Moreover, the inventory module is tied into the accounting module at this point, so that bookkeeping can be set to be performed automatically. This automated bookkeeping can facilitate the bookkeeping process for a lot of smaller businesses that cannot afford to hire full-time book keepers or accountants. For example, when inventory is scanned out, an entry may be made in the accounting books that debits (reduces) an inventory asset account and credits (increases) an inventory expense account, thus automatically expensing the inventory. As a result, this process no longer has to be performed manually. Similarly, the payroll module, the contact management module, and the billing module can also be tied to the accounting module in the sense that the bookkeeping can be automated.

When a registered user 410 signs on to workstation 406, the user's task screen 412 can instruct the user based on input from global workflow 414 and a client contact workflow 416 for a particular patient. For example, the user can be instructed to order a particular item in a particular amount, and to schedule the patient for a particular procedure with a specified staff physician. Scheduling of the procedure can result in reservation of a certain amount of an item for the procedure. Then, when another user signs in at workstation 408, that user's task screen 418A and 418B can instruct the user to scan received items into and out of inventory. If the user attempts to scan out the reserved item for another patient, and if there is not a sufficient surplus of the item, then the user can be notified that the item is reserved and prevented from scanning it out.

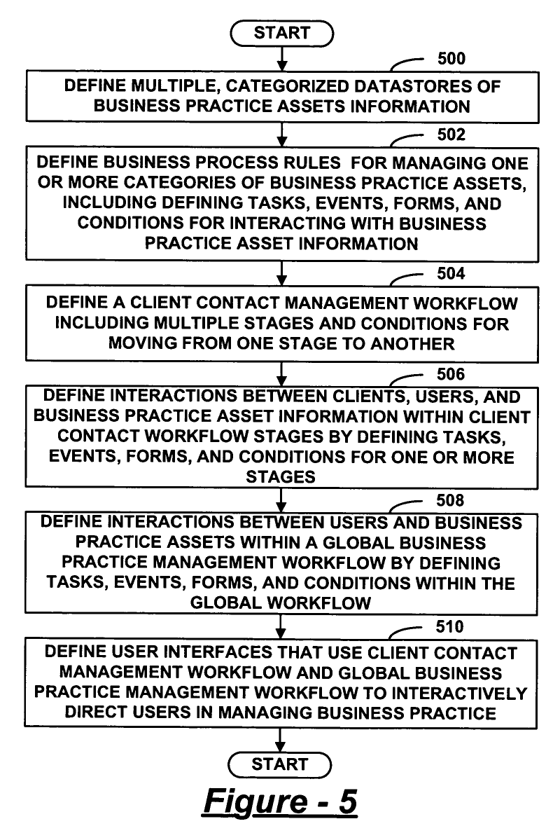

Turning now to FIG. 5, a method of manufacturing a business practice management system in accordance with the present invention begins with defining a plurality of business asset information databases at step 500, such as inventory, client accounts, employees, and records databases. At step 502, business process rules are defined for managing categories of asset information, including tasks, events, forms, and conditions for interacting with the asset information. At step 504, a client contact management workflow is defined, including multiple stages of interaction between users of the system and clients of a business practice, including conditions for moving from one stage to another. The business process rules can define interactions between the users of the system, the clients of the business practice, and information relating to the assets of the business practice, as tasks, events, forms, and conditions within multiple stages of the client contact management workflow.

At step 508, interactions are also defined independently of client contact stages between users of the system and one or more of the categories of assets of the business practice within a global business practice management workflow by defining tasks, events, forms, and conditions within the global workflow. At step 510, one or more user interfaces are defined that use the client contact management workflow and the global business practice management workflow to interactively direct the users of the system in managing the assets of the business practice. Preferably, the tasks, events, forms, and conditions are adapted to direct the users in managing multiple categories of assets of the business, including employees, client accounts, inventory, and records.

As should be readily apparent from the details of the system provided above, the method can include defining an inventory management module that allows the users of the system to record amounts of items in inventory by scanning the items in and out using a bar code scanner, directs users of the system in ordering more inventory based on the amounts, allows users to make a reservation of an amount of an item for scheduled use, and prevents users from successfully scanning out the item based on the amount, the reservation, and a conflict with the scheduled use of the item. It can also include defining a reporting module that allows users of the system to make and store records relating to one or more of goods supplied to clients or services rendered to clients, and to access the records. It can further include defining a payroll and accounting module that manages payment of employees of the business practice by automatically recording access of the system by the users, allows users of the system to place orders for inventory of the business practice, and records and communicates client account statuses. It can still further include providing a billing module that allows users of the system to automatically generate bills based on one or more of goods and services rendered to a client of the business practice.

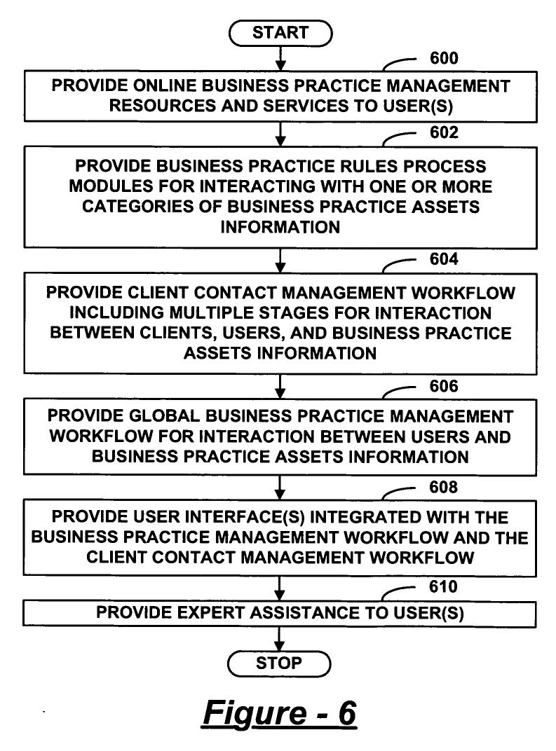

Turning now to FIG. 6, a method of providing an online business practice management system in accordance with the present invention includes providing online business practice management resources and services to users at step 600, including an online workspace via which users interact with business practice assets information. At step 602, business practice rules process modules are provided for interacting with one or more categories of the business practice assets information. These and other provided modules can be built for the user on a custom basis, and/or can be modified versions of legacy systems of the users. At step 604, a client contact management workflow is provided, including multiple stages for interaction between clients, the users, and the business practice assets information. At step 606, a global business practice management workflow can be provided for interaction between the users and the business practice assets information that is independent of the client contact workflow stages. At step 608 user interfaces are provided that are integrated with the client contact management workflow and the global business practice management workflow to accomplish management of assets of the business practice by directing the users in interacting with the clients and/or the business practice assets information. At step 610, expert assistance is provided to users as needed either in person or online to build, update, edit, and/or operate the system.

It should be readily understood that the method can further include managing business practice assets including employees, client accounts, records, and inventory. It can also include allowing users at the business practice to scan items in and out of inventory using a bar code scanner. It can still further include reserving items of inventory for scheduled services to clients and preventing removal of the items from inventory for other purposes. It can yet further include generating a client invoice based on goods and services received by the client and directing employees to invoice the client.

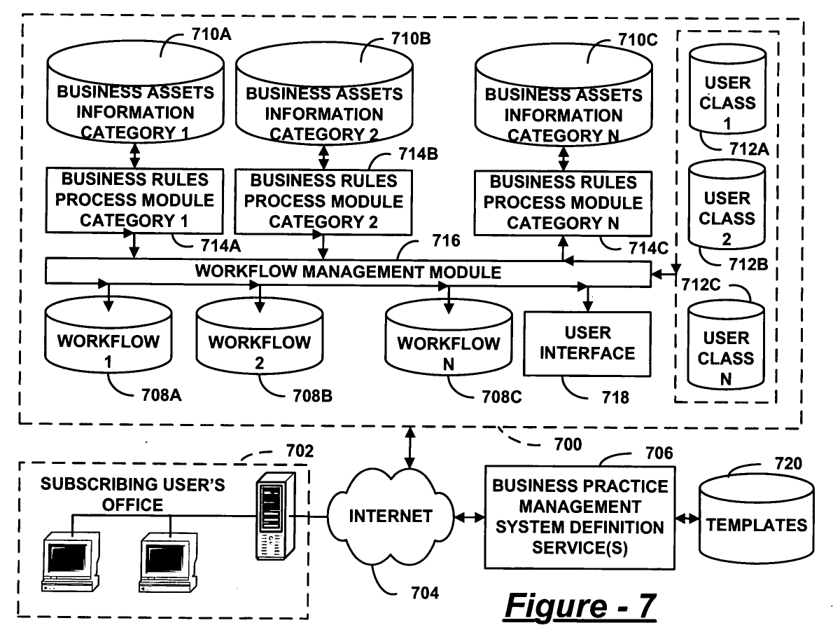

Turning now to FIG. 7, an online business practice manager generation system in accordance with the present invention includes a workspace 700 provided to a subscribing user 702 over a communications system 704, such as the Internet. Business practice management system definition services 706 are discoverable by the subscribing user 702 employing the workspace 700. These services 706 allow the user to define workflows 708A-708C, business asset categories 710A-710C, user classes 712A-712C, and business rules processes 714A-714C within the workspace 700 according to interaction with the subscribing user 702. Workflow management module 716 and user interface 718 can also be provided to link multiple workflows, multiple datastores of categorized assets information, multiple business rules processes, and multiple classes of users to affect operation as described above and in various other, customized fashions that will be readily apparent to those skilled in the art. One or more updateable templates databases 720 can be provided that allow the user to select workflows, business rules processes, business asset information categories, user classes, etc. that have been developed to fulfill the needs of a variety of types of business practices. These templates are preferably easily modifiable to accommodate customization and changing needs of business practices.

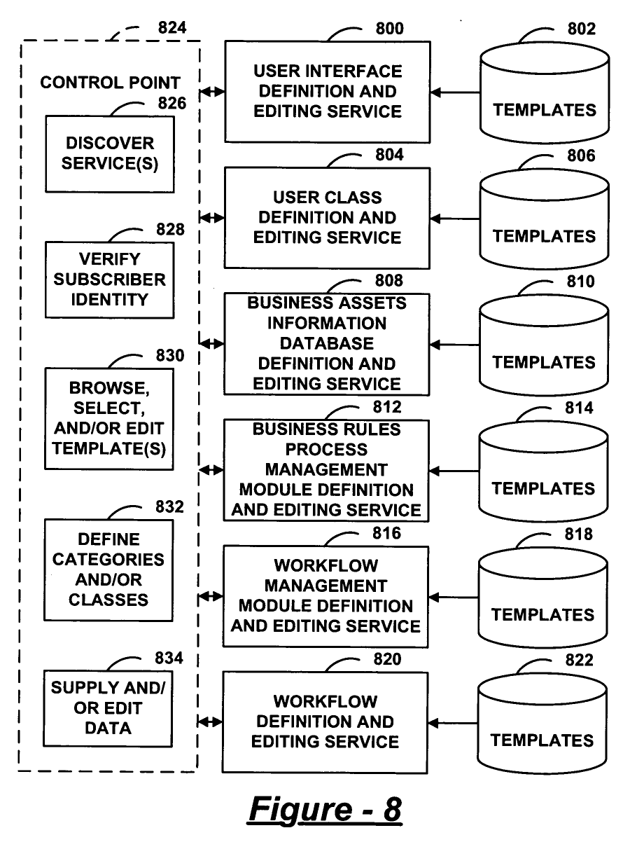

Turning finally to FIG. 8, business practice manager generation services of the online business practice manager generation system in accordance with the present invention can include a user interface definition and editing service 800 that allows the user to define one or more user interfaces. The user interface definition and edition service 800 can allow the user to select and edit a plurality of user interface templates 802 authored to fulfill the needs of a variety of business practices. The services can also include a user class definition and editing service 804 that allows the user to define one or more user classes. The user class definition and editing service can allow the user to select and edit a plurality of user class templates 806 authored to fulfill the needs of a variety of business practices. The services can further include a business assets information database definition and editing service 808 operable to allow the user to define one or more asset information databases. The business assets information database definition and editing service 808 can allow the user to select and edit a plurality of database templates 810 authored to fulfill the needs of a variety of business practices.

Other services can also be provided. For example, a business rules process management module definition and editing service 812 can allow a user to define one or more business rules processes. The business rules process management module definition and editing service can allow the user to select and edit a plurality of business rules process management module templates 814 authored to fulfill the needs of a variety of business practices. Also, a workflow management module definition and editing service 816 can allow a user to define one or more workflow management modules. The workflow management module definition and editing service 816 can allow the user to select and edit a plurality of workflow management module templates 818 authored to fulfill the needs of a variety of business practices. Finally, a workflow definition and editing service 820 can allow the user to define one or more workflows. The workflow definition and editing service 820 can allow the user to select and edit a plurality of workflow templates 822 authored to fulfill the needs of a variety of business practices.

The services described above can be adapted to constrain the available templates based on previous selections made by the user employing other services. For example, the user can first select one or more categories of business practices, select a user interface type, select from the presented the user classes, change or add user classes, and select, change or add categories of business assets information. The user can be required to define access privileges of classes of users with respect to categories and/or subcategories of asset information. The user's legacy databases can be uploaded and associated with a selected or defined category. Next, the user can be presented with a number of different workflows that most closely match the anticipated needs of the user, which the user can select and/or change. The user can also create their own workflow, including custom stages and conditions for completion. Tasks, forms, events, and conditions can be selected form a constrained list of candidates by drag and drop into meaningful positions in the stages. The user can be required to define for tasks the class of user to be assigned, and for forms the category and/or subcategory of information to be managed. The user can also create new, custom forms, conditions, events, and tasks. It is even possible that the user's legacy forms can be uploaded and integrated into the workflow.

Each service is adapted to be discovered by the users control point, which is a function of the workspace of the user. By subscribing to the workspace, the user can be identified as a function of the workspace as can the user's privileges and subscription status. Using the control point 824, the user can discover the services 826, verify the subscriber identity 828, browse, select, and/or edit templates 830, define categories, classes, workflows, etc. 832, and supply and/or edit data 834. As a result, the task of creating and later modifying the user's preferred business practice management system is greatly facilitated, without requiring the user to invest in onsite products and equipment.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A business practice management system, comprising:
a client contact management workflow including multiple stages of interaction between users of the system and clients of a business practice, including conditions for moving from one stage to another, said client contact management workflow defining interactions between the users of the system, the clients of the business practice, and information relating to the assets of the business practice, including tasks, events, forms, and conditions defined within multiple stages of the client contact management workflow;
a global business practice management workflow defining interactions between users of the system and one or more of the categories of the assets of the business practice independently of client contact stages, including tasks, events, forms, and conditions within the global workflow; and
one or more user interfaces that use the client contact management workflow and the global contact management workflow to interactively direct the users of the system in managing the assets of the business practice, wherein the tasks, events, forms, and conditions are adapted to direct the users in managing multiple categories of assets of the business, including employees, client accounts, inventory, and records.

2. The system of claim 1, further comprising one or more datastores for one or more categories of the information relating to one or more categories of the assets of the business practice.

3. The system of claim 1, further comprising business practice rules for managing one or more categories of the assets of the business practice, including tasks, events, forms, and conditions for interacting with the information relating to the assets.

4. The system of claim 1, further comprising an inventory management module that allows the users of the system to record amounts of items in inventory by scanning the items in and out of inventory using a bar code scanner.

5. The system of claim 1, further comprising an inventory management module that is integrated with said global business practice management workflow to direct users of the system in ordering more inventory based on the amounts of inventory and one or more inventory amount thresholds.

6. The system of claim 1, further comprising an inventory management module that is integrated with said client contact management workflow to reserve of an amount of an item for scheduled use in fulfilling needs of a client, and prevents users from removing the item from inventory based on the amount, the reservation, and a conflict with the scheduled use of the item.

7. The system of claim 1, further comprising a reporting module that allows users of the system to make and store records relating to one or more of goods supplied to clients or services rendered to clients, and to access the records.

8. The system of claim 1, further comprising a reporting module that is integrated with said client contact management workflow to direct users of the system to generate reports.

9. The system of claim 1, further comprising a payroll module that manages payment of employees of the business practice by automatically recording access of the system by employee users and calculating time worked by employees according to times of access.

10. The system of claim 1, further comprising an accounting module connected to an inventory management module that allows the users of the system to add items to inventory and remove items from inventory, wherein said accounting module and said inventory management module are configured to perform an automated bookkeeping function based on at least one of addition of items to inventory or removal of items from inventory.

11. The system of claim 10, wherein said inventory management module allows the users to add and remove items by scanning the items in and out of inventory using a bar code scanner, and the automated bookkeeping function is implemented to ensure that an entry is made in accounting books that debits an inventory asset account and credits an inventory expense account when inventory is scanned out, thus automatically expensing the inventory.

12. The system of claim 10, further comprising a payroll module, and a billing module, wherein the said contact management module, said payroll module, and said billing module are connected to said accounting module and configured to accomplish the automated bookkeeping functions based on actions of staff, payment of staff, and billing of one or more of clients and other responsible parties.

13. The system of claim 1, further comprising an accounting module integrated with said global business practice management workflow to allow users of the system to pay suppliers of inventory of the business practice.

14. The system of claim 1, further comprising an accounting module integrated with said client contact management workflow to allow users of the system to view and modify client account statuses, including invoicing clients of the business practice and marking client accounts as paid.

15. The system of claim 1, further comprising a billing module integrated with said client contact management workflow to allows users of the system to automatically generate bills based on one or more of goods and services rendered to a client of the business practice.

16. The system of claim 15, wherein said billing module is adapted to recommend specific billing codes based on procedures being performed.

17. A method of manufacturing a business practice management system, comprising:
defining a client contact management workflow including multiple stages of interaction between users of the system and clients of a business practice, including conditions for moving from one stage to another;
defining interactions between the users of the system, the clients of the business practice, and information relating to the assets of the business practice, including defining tasks, events, forms, and conditions within multiple stages of the client contact management workflow; and
defining one or more user interfaces that use the client contact management workflow to interactively direct the users of the system in managing the assets of the business practice, wherein the tasks, events, forms, and conditions are adapted to direct the users in managing multiple categories of assets of the business, including employees, client accounts, inventory, and records.

18. The method of claim 17, further comprising defining interactions between users of the system and one or more of the categories of assets of the business practice within a global business practice management workflow independently of client contact stages, including defining tasks, events, forms, and conditions within the global workflow.

19. The method of claim 18, further comprising defining one or more user interfaces that use the client contact management workflow and the global business practice management workflow to interactively direct the users of the system in managing the assets of the business practice.

20. The method of claim 17, further comprising defining one or more datastores for one or more categories of the information relating to one or more categories of the assets of the business practice.

21. The method of claim 17, further comprising defining business practice rules for managing one or more categories of the assets of the business practice, including defining tasks, events, forms, and conditions for interacting with the information relating to the assets.

22. The method of claim 17, wherein the tasks, events, forms, and conditions are defined within multiple stages of the client contact management workflow, and are adapted to direct the users of the system to manage employees, client accounts, inventory, and records of the business practice.

23. The method of claim 17, further comprising defining an inventory management module that allows the users of the system to record amounts of items in inventory by scanning the items in and out using a bar code scanner, directs users of the system in ordering more inventory based on the amounts, allows users to make a reservation of an amount of an item for scheduled use, and prevents users from successfully scanning out the item based on the amount, the reservation, and a conflict with the scheduled use of the item.

24. The method of claim 17, further comprising defining a reporting module that allows users of the system to make and store records relating to one or more of goods supplied to clients or services rendered to clients, and to access the records.

25. The method of claim 17, further comprising defining a payroll and accounting module that manages payment of employees of the business practice by automatically recording access of the system by the users, allows users of the system to place orders for inventory of the business practice, and records and communicates client account statuses.

26. The method of claim 17, further comprising providing a billing module that allows users of the system to automatically generate bills based on one or more of goods and services rendered to a client of the business practice.

27. An online business practice manager generation system, comprising:
a workspace provided to a subscribing user over a communications system;
a plurality of business practice management system definition services discoverable by said subscribing user employing said workspace,
wherein said services are operable to define workflows, business asset classes, user classes, and business rules processes within said workspace according to interaction with said subscribing user.

28. The system of claim 27, further comprising a user interface definition and editing service operable to allow the user to define one or more user interfaces.

29. The system of claim 28, wherein said user interface definition and edition service is operable to allow the user to select and edit a plurality of user interface templates authored to fulfill the needs of a variety of business practices.

30. The system of claim 27, further comprising a user class definition and editing service operable to allow the user to define one or more user classes.

31. The system of claim 30, wherein said user class definition and editing service is operable to allow the user to select and edit a plurality of user class templates authored to fulfill the needs of a variety of business practices.

32. The system of claim 27, further comprising a business assets information database definition and editing service operable to allow the user to define one or more asset information databases.

33. The system of claim 32, wherein said business assets information database definition and editing service is operable to allow the user to select and edit a plurality of database templates authored to fulfill the needs of a variety of business practices.

34. The system of claim 27, further comprising a business rules process management module definition and editing service operable to allow a user to define one or more business rules processes.

35. The system of claim 34, wherein said business rules process management module definition and editing service is operable to allow the user to select and edit a plurality of business rules process management module templates authored to fulfill the needs of a variety of business practices.

36. The system of claim 27, further comprising a workflow management module definition and editing service operable to allow a user to define one or more workflow management modules.

37. The system of claim 36, wherein said workflow management module definition and editing service is operable to allow the user to select and edit a plurality of workflow management module templates authored to fulfill the needs of a variety of business practices.

38. The system of claim 27, further comprising a workflow definition and editing service operable to allow the user to define one or more workflows.

39. The system of claim 28, wherein said workflow definition and editing service is operable to allow the user to select and edit a plurality of workflow templates authored to fulfill the needs of a variety of business practices.

40. A client contact management workflow software system, comprising:
a plurality of linearly ordered client contact workflow stages, wherein each stage is composed of required tasks, events, forms, and conditions, including conditions for stage completion, said stages including:
(a) an inquiry stage directing employees to collect and update information about a client;
(b) an appointment stage following completion of said inquiry stage, said appointment stage indicating that employees have scheduled an appointment for the client to meet with staff for a consultation; and
(c) a consultation stage following completion of said appointment stage, said consultation stage generating a consultation task for the staff based on the appointment, and recording information provided by the staff about results of the consultation.

41. The system of claim 40, further comprising:
(d) one or more procedures stages following completion of said consultation stage, one or more of said procedures stages signifying that at least one procedure has been booked, reserving inventory allocated for performing the one or more booked procedures, generating a bill for goods and services received by the client, directing the employees to invoice the client for the goods and services, generating one or more procedure tasks to be performed by the staff, and recording information provided by the staff about results of one or more of the procedures following completion thereof.

42. The system of claim 41, wherein said procedures stages are operable to direct employees to schedule a follow up for the client to meet with the staff following the procedure, the system further comprising:
(e) a follow up stage following completion of said procedures stage, said follow up stage generating a follow up task to be performed by the staff based on the scheduling of the follow up, and recording information provided by the staff about results of the follow up.

43. The system of claim 41, wherein said procedures stages further directs employees to remove items from inventory based on booked procedures.

44. The system of claim 41, wherein said procedures stages include two sequential stages, wherein a first stage is signifies that an appointment for a procedure has been booked and triggers tasks, events, and conditions that must be satisfied before a second of the stages, which triggers all of the tasks, events, and conditions that must be completed on a day of the procedure.

45. The system of claim 40, further comprising a global business practice management workflow directing employees to order items when a number of the items in inventory falls below a predetermined threshold.

46. The system of claim 40, further comprising a global business practice management workflow directing employees to enter items into inventory using a bar code scanner.

47. A method of providing online business practice management system, comprising:
providing online business practice management resources and services to users, including an online workspace via which users interact with business practice assets information;
providing business practice rules process modules for interacting with one or more categories of the business practice assets information;
providing a client contact management workflow including multiple stages for interaction between clients, the users, and the business practice assets information;
providing user interfaces integrated with the client contact management workflow to accomplish management of assets of the business practice by directing the users in interacting with the clients and the business practice assets information.

48. The method of claim 47, further comprising:
providing a global business practice management workflow for interaction between the users and the business practice assets information independently of client contact stages; and
providing user interfaces integrated with the global business practice management workflow to accomplish management of assets of the business practice by directing the users in interacting with the business practice assets information.

49. The method of claim 47, further comprising managing business practice assets including employees, client accounts, records, and inventory.

50. The method of claim 47, further comprising allowing users at the business practice to scan items in and out of inventory using a bar code scanner.

51. The method of claim 47, further comprising reserving items of inventory for scheduled services to clients and preventing removal of the items from inventory for other purposes.

52. The method of claim 47, further comprising generating a client invoice based on goods and services received by the client and directing employees to invoice the client.

53. A method of operation for an anatomical notation system, comprising:
presenting a user with a display of a plurality of icons representing selectable anatomical systems in the form of a dynamically rendered illustration of a human body;
varying display properties of selectable anatomical systems based on notes recorded in association with the selectable anatomical systems;
detecting user selection of one of the selectable anatomical systems;
adjusting the display to render the anatomical system selected by the user;
allowing the user to select a portion of a rendered anatomical system;
adjusting the display to enlarge display of the portion selected by the user, if any;
displaying notes recorded for the rendered anatomical system, if any;
displaying predetermined, selectable diagnoses for the rendered anatomical system;
accepting user specification of one or more notes and diagnoses associated therewith; and
recording user-specified notes and diagnoses in association with the anatomical system.

54. A medical information management system, comprising:
a datastore storing medical records including lab results and medical images;
a medical information management module adapted to access, retrieve, and store medical records, including lab results and medical images, in said datastore by employing a proprietary language; and
a translator module that allows multiple Electronic Medical Record (EMR) systems to speak to said medical information management module and to use that module as a means to communicate with each other, wherein said translator module is adapted to be connected between said medical information management module and the EMR systems, and to translate the languages that those EMR systems speak into the proprietary language and vice versa.

55. The system of claim 54, wherein a messaging language that can be understood by said translator module is Health Level 7 (HL7).

56. The system of claim 54, wherein a messaging language that can be understood by said translator module is the DICOM standard that has been created for medical images.

57. The system of claim 56, wherein said translator module is adapted to accept messages and store data in said database, and to accept requests for data and send data out to a requesting EMR application.
